(19) United States
(12) Patent Application Publication
(10) Pub. No.: US 2013/0038422 A1
(43) Pub. Date: Feb. 14, 2013

(54) METHOD AND SYSTEM OF REDUCING THE TEMPERATURE OF AN INTEGRATED CIRCUIT AND A DIGITAL COMMUNICATION SYSTEM USING SAME

(71) Applicant: Keng Leong FONG, Sunnyvale, CA (US)

(72) Inventor: Keng Leong FONG, Sunnyvale, CA (US)

(73) Assignee: Ralink Technology Corporation, Jhubei City (TW)

(21) Appl. No.: 13/208,166

(22) Filed: Aug. 11, 2011

(51) Int. Cl. G05B 23/02

(52) U.S. Cl. 340/3.1

(57) ABSTRACT

A method and system for reducing the temperature of a communication system are disclosed. The method and system comprise detecting a temperature of the communication system. The method and system further includes providing a signal based upon the detected temperature, and determining a desired idle time between transmit packets based upon the signal. Finally, the method and system includes sending the desired idle time between transmit packets to the communication system.

### FIELD OF THE INVENTION

The present invention relates generally to digital communication systems and more specifically to reducing the temperature in such systems.

### BACKGROUND OF THE INVENTION

In semiconductor technology, both the sizing and geometry of integrated circuits have consistently become smaller and smaller over the years, causing more hardware circuitry to be packed within each chip package or die. As a result of integrating more functionality and power amplifiers within each unit area, operating temperatures of many integrated circuits have become exceedingly high resulting in system instability and failure.

One approach to resolving the issue of high temperature integrated circuitry is the addition of a heat sink on the integrated circuit package. However, this solution substantially increases the manufacturing costs.

A second approach to reducing the integrated circuit temperature is to reduce the transmitter output power of the communication system. However, this method also decreases the wireless transmission range of the communication system.

Accordingly, what is needed is a method and system for reducing the temperature in an integrated circuit board. The method and system should be cost effective, easily implemented and adaptable to existing environments. The present invention addresses such a need.

### SUMMARY OF THE INVENTION

The present invention satisfies this need, and presents a method and system for reducing the temperature of an integrated circuit. To achieve the above object, the present method is described as detecting a temperature of a communication system. The method and system further includes providing a signal based upon the detected temperature, and determining a desired idle time between transmit packets based upon the signal. Finally, the method and system includes sending the desired idle time between transmit packets to the communication system.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is an illustration of a communication temperature control scheme in accordance with an embodiment.

FIG. 2 illustrates a first embodiment of an algorithm used to implement the idle time decision block.

FIG. 3 illustrates the use of dual temperature threshold values in a second embodiment of an algorithm.

FIG. 4 is a block diagram of a RF transmitter system that utilizes the temperature control scheme in accordance with an embodiment.

### DETAILED DESCRIPTION

The present invention relates generally to digital communication systems and more specifically to reducing the temperature in such systems.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A method and system in accordance with the present invention uses a temperature control scheme to detect the temperature of either an integrated circuit or of the communication system itself. Once the temperature is detected, the temperature information is sent to and idle time decision block where an idle time between transmit packets is determined and later sent to a communication system. In doing so, both reliability and efficiency of the communication system are improved because lower temperatures are sustained while consuming less overall system power. The temperature control scheme in accordance with the present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device. The temperature control scheme in accordance with the present invention can also be implemented in hardware or application specific integrated circuits (ASIC).

The medium can be an electronic, magnetic, optical, electromagnetic, infrared, or a semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk—read/write (CD-R/W). To describe the features of the present invention in more detail, refer now to the following description in conjunction with the accompanying Figures.

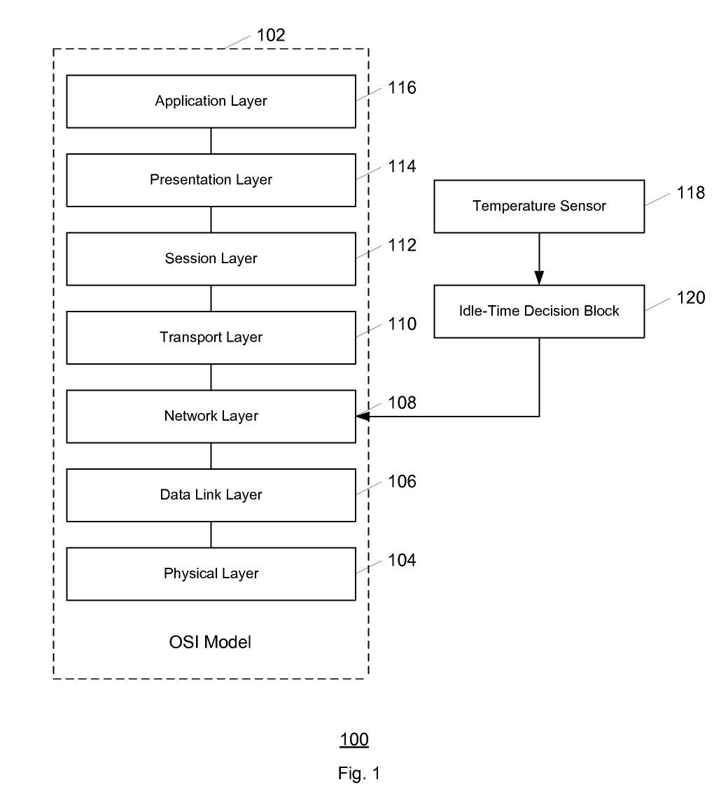

FIG. 1 is an illustration of a communication temperature control scheme 100 in accordance with an embodiment. The temperature control scheme 100 is shown within the context of an Open System Interconnection Reference Model (OSI Model) Communication System, 102. The illustrated OSI Model 102 comprises a plurality of layers including: a physical layer 104, a data link layer 106, a network layer 108, a transport layer 110, a session layer 112, a presentation layer 114, and an application layer 116. Each of these layers provides services to its upper layer while receiving services from the layer immediately below it. For example, the data link layer 106 may provide services to the “upper” network layer 108, while simultaneously receiving services from the “lower” physical layer 104.

On this embodiment, a temperature sensor block 118 detects the temperature of the communication system 102, and sends the information to an idle time decision block (ITDB) 120. Based on the temperature received by the temperature sensor 118, an ITDB 120 calculates a desired idle time between transmit packets. If the temperature has risen, the idle time is increased by the idle time block 120 in order to reduce the transmit duty cycle, and hence the temperature. If the temperature has fallen, the idle time is decreased by the ITDB 120 in order to increase the data throughput. The desired idle time between transmit packets is then sent to any of the seven layers of the OSI model communication system 102, although in FIG. 1 (by example) it is sent to the network layer 108. The ITDB 120 can be implemented in either software or hardware.

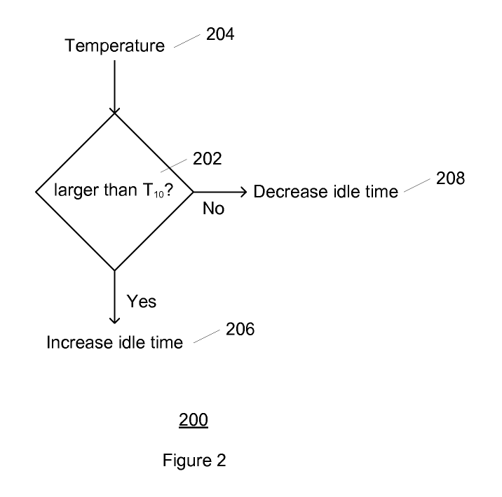

A key feature of the present invention is the ITDB 120 can be implemented in accordance with one or more algorithms. Two of these algorithms will be discussed further. FIG. 2 illustrates a first embodiment of an algorithm 200 used to implement the ITDB 120 using a single temperature threshold value Tₜ₀. A temperature signal threshold value Tₜ₀ (202) is evaluated against a temperature signal obtained from the temperature sensor 118 via decision block 201. The detected temperature signal can be any signal such as voltage, current, temperature, displacement, stress, or strain, as long as the detected signal provides the temperature information.

For example, in this embodiment, if the temperature from the temperature sensor 118 is more than the threshold value Tₜ₀ (202), the idle time will be increased between packets. However, if the temperature from the temperature sensor 118 is less than the signal threshold value Tₜ₀ (202), the idle time will be decreased between the packets. In so doing, the temperature of the device can be effectively controlled. Although this system works effectively, it has a disadvantage in some environments where the temperature fluctuates around the threshold value which may require the idle time to be adjusted frequently.

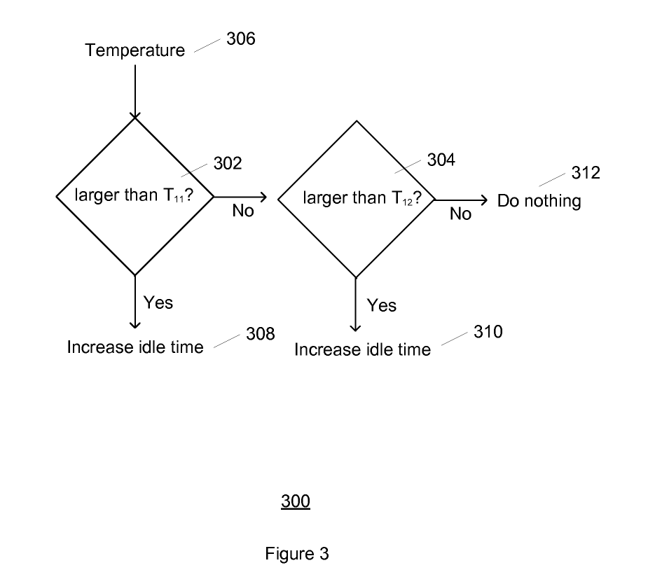

Therefore, to address this issue, another possible approach to implementing the ITDB 120 involves the use of dual temperature threshold values. FIG. 3 illustrates the use of dual temperature threshold values Tₜ₁ and Tₜ₂ in a second embodiment of an algorithm 300. In this embodiment, the first threshold value Tₜ₁ (302) may be larger than the second threshold value Tₜ₂ (304). Both temperature threshold values Tₜ₁ (302) and Tₜ₂ (304) are evaluated against a temperature signal obtained from the temperature sensor (306). For example, in this embodiment, if the temperature signal from the temperature sensor 306 is larger than Tₜ₁ (302), the algorithm 300 sends a signal 308 to the network layer 108 to increase the idle time. If the temperature signal 310 from the temperature sensor 118 is smaller than Tₜ₂ (304), the algorithm 300 sends a signal to the network layer 108 to decrease the idle time. If the temperature signal is found to be within the range of Tₜ₁ (302) and Tₜ₂ (304), the algorithm 300 either sends no signal, or in the alternative, may send a signal 312 indicating no actions are required. This embodiment illustrates the advantage of using two threshold values because the need to make frequent adjustments to the idle time is greatly reduced.

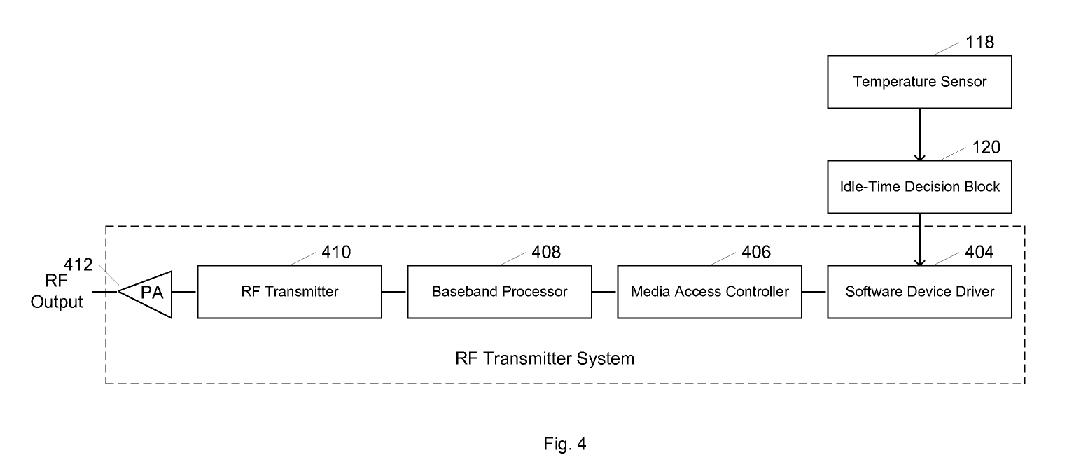

A method and system in accordance with the present invention can be utilized in a variety of environments. FIG. 4 is a block diagram of a RF transmitter system 400 that utilizes the temperature control scheme 100 in accordance with an embodiment. The RF transmitter system 400 includes a software device driver 404, coupled to a media access controller (MAC) 406.

A baseband processor (BBP) 408 is coupled to a RF transmitter 410, and a power amplifier 412. The temperature sensor block 118 detects the temperature of the integrated circuit or the system. Though in FIG. 4 the temperature control scheme 100 is coupled to the software device driver 404, it can also be coupled to the MAC 406 or the baseband processor 408. Based on the temperature information, the ITDB 120 calculates the desired idle time between transmit packets. If the detected temperature information indicates that the temperature has risen, the idle time is increased in order to reduced the transmit duty cycle, and hence the temperature. If the detected temperature information indicates that the temperature has fallen, the idle time is decreased in order to increase the data throughput. The desired idle time between transmit packets is then sent to the software device driver 404. In addition to being implemented as a separate block, the ITDB 120 can be implemented as part of the software device driver 404, or within the MAC 406. As before mentioned an ITDB 120 can be implemented in a variety of ways including but not limited to those disclosed in FIGS. 2 and 3.

One advantage of a system and method in accordance with the present invention is improved system reliability and performance because less power is consumed in the operation of the overall communication system.

A second advantage of a system and method in accordance with the present invention is the reduced overall operating cost since less power is consumed in the operation of the overall communication system.

A third advantage of a system and method in accordance with the present invention is the ability to operate the communication system with reduced temperatures without affecting the wireless transmission range since the transmitter output power does not need to be reduced.

A fourth advantage is the elimination of the need of a head sink and/or an expensive IC package which would increase both the overall communication system cost and form factor.

Although the present invention has been described in accordance with the embodiments shown, one of ordinary skill in the art will readily recognize that there could be variations to the embodiments and those variations would be within the sprit and scope of the present invention. Accordingly, many modifications may be made by one of ordinary skill in the art without departing from the spirit and scope of the appended claims.

What is claimed is:

1. A method for reducing the temperature of a communication system comprising:
detecting a temperature of the communication system;
providing a signal based upon the detected temperature;
determining a desired idle time between transmit packets based upon the signal; and
sending the desired idle time between transmit packets to the communication system.

2. The method of claim 1, wherein the signal comprises a temperature signal.

3. The method of claim 1, wherein the determining step comprises utilizing a temperature threshold value to increase the desired idle time if the signal is larger than the temperature threshold value, and wherein the idle time is decreased if the signal is smaller than the temperature threshold value.

4. The method of claim 1, wherein the determining step comprises utilizing a first temperature threshold value to increase the idle time if the signal is larger than the first temperature threshold value, wherein the idle time is decreased if the signal is smaller than the first temperature threshold value and smaller than a second temperature threshold value, wherein no change is made to the idle time if the signal is smaller than the first temperature threshold value and larger than the second temperature threshold value.

5. The method of claim 1, wherein the communication system comprises an Open System Interconnection Reference (OSI) Model.

6. The method of claim 1, wherein the communication system comprises an integrated circuit.

7. A system for reducing the temperature of a communication system comprising:
a temperature sensor coupled to the communication system; and
an idle time decision block (ITDB) for receiving a signal from the temperature sensor indicative of the temperature of the communication system; wherein the ITDB determines a desired idle time between transmit packets based upon the signal and sends the desired idle time between transmit packets to the communication system.

8. The system of claim 7 wherein the communication system comprises a plurality of layers including a physical layer, a data link layer, a network layer, a transport layer, a session layer, a presentation layer, and an application layer; wherein each layer provides services to an upper layer while simultaneous receiving services from the layer immediately below it.

9. The system of claim 8 wherein the ITDB determines a desired idle time between transmit packets and sends the information to one of the plurality of layers.

10. The system of claim 8 wherein the communication system comprises a RF transmitter system.

11. The system of claim 10 wherein the RF transmitter system comprises a software device driver coupled to a media access controller (MAC), a baseband processor (BBP) coupled between the MAC and a RF transmitter, and a power amplifier coupled to the output of the RF transmitter.

12. The system of claim 11 wherein the MAC is coupled to the ITDB.

13. The system of claim 11 wherein the baseband processor is coupled to the ITDB.

14. The system of claim 11 wherein the software device driver is coupled to the ITDB.

15. A computer readable medium containing programming instructions to be executed by a computer, the program instructions for reducing the temperature of a transceiver integrated circuit comprising:
detecting a temperature of a communication system;
providing a signal based upon the detected temperature;
determining a desired idle time between transmit packets based upon the signal; and
sending the desired idle time between transmit packets to the communication system.

16. The computer readable medium of claim 15, wherein the determining step comprises utilizing a temperature threshold value to increase the desired idle time if the signal is larger than the temperature threshold value, and wherein the idle time is decreased if the signal is smaller than the temperature threshold value.

17. The computer readable medium of claim 15, wherein the determining step comprises utilizing a first temperature threshold value to increase the idle time if the signal is larger than the first temperature threshold value, wherein the idle time is decreased if the signal is smaller than the first temperature threshold value and smaller than a second temperature threshold value, wherein no change is made to the idle time if the signal is smaller than the first temperature threshold value and larger than the second temperature threshold value.
